(19) United States
(12) Patent Application Publication
(10) Pub. No.: US 2026/0099859 A1
(43) Pub. Date: Apr. 9, 2026

(54) METHOD AND APPARATUS FOR A LOYALTY EXCLUSIVE AWARD PERSONALIZATION (LEAP) FEATURE OF A CENTRALIZED TRAVEL PROGRAM MANAGEMENT SYSTEM

(71) Applicant: nuTravel Technology Solutions, Inc., Purchase, NY (US)

(72) Inventors: Michael Harbin, Chicago, IL (US); Rich Hunt, Ossining, NY (US)

(73) Assignee: nuTravel Technology Solutions, Inc., Purchase, NY (US)

(21) Appl. No.: 19/349,478

(22) Filed: Oct. 3, 2025

Related U.S. Application Data
(63) Continuation-in-part of application No. 17/478,082, filed on Sep. 17, 2021.
(60) Provisional application No. 63/080,912, filed on Sep. 21, 2020.
(60) Provisional application No. 63/755,327, filed on Feb. 7, 2025.

(51) Int. Cl. G06Q 30/0226; G06Q 30/0207

(52) U.S. Cl. CPC G06Q 30/0229; G06Q 30/0225

(57) ABSTRACT

A loyalty exclusive award personalization (LEAP) feature of a centralized travel benefit management system is disclosed. The loyalty exclusive award personalization (LEAP) feature of the centralized travel benefit management system comprises at least one processor communicatively coupled with a memory. The at least one processor is configured to receive a set of one or more travel benefits; store the one or more travel benefits in a centralized ledger; provide an access to a travel manager to assign the one or more travel benefits to the one or more travelers within an enterprise; combine the one or more travel benefits into a bundled benefit; determine, whether the at least one traveler is authorized to use the bundled benefit; send the bundled benefit to a merchandising system of the at least one travel supplier; determine whether the bundled benefit presented to the at least one traveler is redeemed by the at least one traveler; and update the centralized ledger in real time.

### CROSS REFERENCE TO RELATED APPLICATION

This non-provisional patent application claims the benefit under 35 U.S.C. § 199(e) of U.S. Provisional Patent Application Ser. No. 63/755,327, filed Feb. 7, 2025, and also claims the benefit under 35 U.S.C. § 120 as a continuation-in-part patent application of U.S. patent application Ser. No. 17/478,082, filed Sep. 17, 2021, which claims the benefit under 35 U.S.C. § 199(e) of U.S. Provisional Patent Application Ser. No. 63/080,912, filed Sep. 21, 2020 (and the Appendixes/Attachments filed therewith), the disclosures of each of which are all incorporated herein by reference.

### TECHNOLOGICAL FIELD OF THE INVENTION

The present invention relates generally to a new class of ancillary product control and value add for the travel industry by enabling suppliers and corporate travel managers to automate the allocation and utilization of negotiated soft values, and relates more particularly to the dynamic management through an administrative portal and synchronization with supplier inventory and traveler status of traveler benefits (e.g., Miles/Points awards and exchanges, WiFi, club visits, priority boarding, upgrades, and more) available at the point-of-sale as individual or bundled awards.

### BACKGROUND OF THE INVENTION

Airlines and other travel service providers often offer corporate clients a range of soft dollar benefits such as lounge passes, Wi-Fi vouchers, priority boarding, seat upgrades, or loyalty points. Traditionally, the soft dollar benefits are distributed through manual processes, such as issuing promo codes or vouchers, which can be shared outside an intended company, leading to misuse and loss of value. Corporate travel managers have limited visibility and control over which travelers use the soft dollar benefits, when they are redeemed, and whether they align with corporate travel policies. Furthermore, the travelers often encounter inconsistent redemption processes across different airline platforms, requiring separate logins or manual code entry, which reduces convenience and adoption. Such limitations create operational inefficiencies, increase administrative burden, and prevent airlines and companies from realizing the full value of the soft dollar benefits.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### SUMMARY OF THE INVENTION

The following presents a simplified summary to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, an apparatus for a loyalty exclusive award personalization (LEAP) feature of a centralized travel benefit management system is disclosed. The loyalty exclusive award personalization (LEAP) feature of the centralized travel benefit management system comprises a memory having one or more computer readable instructions. The centralized travel benefit management system further comprises at least one processor communicatively coupled with the memory. The at least one processor executing the one or more computer readable instructions stored in the memory is configured to receive, from at least one travel supplier, a set of one or more travel benefits for one or more travelers associated with one or more enterprises; store the received one or more travel benefits in a centralized ledger, wherein the centralized ledger is configured to maintain benefit status of the one or more travel benefits for the one or more travelers associated with the one or more enterprises; provide, via an administration module communicatively coupled to the at least one processor, an access to a travel manager to assign the one or more travel benefits to the one or more travelers within an enterprise of the one or more enterprises based at least on predefined allocation rules; combine the one or more travel benefits into a bundled benefit for at least one traveler from the one or more travelers; determine, in real time and prior to a redemption event, whether the at least one traveler is authorized to use the bundled benefit based at least on traveler identification data, corporate eligibility rules, and supplier usage restrictions; send, via an application programming interface (API) module, the bundled benefit to a merchandising system of the at least one travel supplier to present the bundled benefit to the at least one traveler, upon determining the at least one traveler is authorized to use the bundled benefit; determine whether the bundled benefit presented to the at least one traveler is redeemed by the at least one traveler; and update the centralized ledger in real time upon determining the bundled benefit is redeemed by the at least one traveler, to synchronize the status across the at least one travel supplier, the travel manager, and the at least one traveler.

In some embodiments, the at least one processor executing the one or more computer readable instructions stored in the memory is further configured to prevent an unauthorized use of the bundled benefit by the at least one traveler by enforcing one or more security mechanisms, upon determining the at least one traveler is not authorized to use the bundled benefit.

In some embodiments, the one or more security mechanisms comprises at least one of encrypted traveler identification mapping, single-account locking, and real-time benefit status validation.

In some embodiments, the traveler identification data comprises at least one of a traveler's name, an email address, an employee identification number, a department code, a corporate policy tier, and a loyalty account number.

In some embodiments, the centralized ledger is further configured to store and track a usage history of each of the one or more travelers, including at least one of redeemed benefits, redemption dates, redemption channels, and remaining benefit entitlements.

In some embodiments, the benefit status of the one or more travel benefits comprises at least one of granted benefits, assigned benefits, redeemed benefits, or expired benefits for each traveler associated with the one or more enterprises.

In some embodiments, the predefined allocation rules comprise at least one of first-come-first-served distribution, traveler seniority-based distribution, travel frequency-based distribution, or route-specific allocation.

In some embodiments, the predefined allocation rules are stored in the memory communicatively coupled to the at least one processor, and dynamically applied by the administration module to assign the one or more travel benefits.

In some embodiments, the at least one processor is configured to authenticate the one or more travelers using a single sign-on mechanism during the redemption event, wherein the single sign-on mechanism is configured to perform multi-factor authentication comprising cryptographic token validation and dynamic session allocation for secure access to at least one travel supplier's booking platform.

In some embodiments, the one or more travel benefits comprise at least one of lounge access passes, in-flight Wi-Fi vouchers, seat upgrades, priority boarding privileges, or loyalty points.

In another example embodiment, a method a loyalty exclusive award personalization (LEAP) feature of centralized travel benefit management system is disclosed. The method comprising steps of receiving, via at least one processor communicatively coupled with a memory, a set of one or more travel benefits for one or more travelers associated with one or more enterprises, from at least one travel supplier; storing, via the at least one processor, the set of one or more travel benefits for the one or more travelers associated with the one or more enterprises; providing, via an administration module communicatively coupled to the at least one processor, an access to a travel manager to assign the one or more travel benefits to the one or more travelers within an enterprise of the one or more enterprises based at least on predefined allocation rules; combining, via the at least one processor, the one or more travel benefits into a bundled benefit for at least one traveler from the one or more travelers; determining, via the at least one processor, in real time and prior to a redemption event, whether the at least one traveler is authorized to use the bundled benefit based at least on traveler identification data, corporate eligibility rules, and supplier usage restrictions; sending, via the at least one processor using an application programming interface (API) module, the bundled benefit to a merchandising system of the at least one travel supplier to present the bundled benefit to the at least one traveler, upon determining the at least one traveler is authorized to use the bundled benefit; determining, via the at least one processor, whether the bundled benefit presented to the at least one traveler is redeemed by the at least one traveler; and updating, via the at least one processor, the centralized ledger in real time upon determining the bundled benefit is redeemed by the at least one traveler, to synchronize the benefit status across the at least one travel supplier, the travel manager, and the at least one traveler.

The above summary is provided merely for purposes of summarizing some exemplary embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained within the following detailed description and its accompanying drawings.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a centralized travel benefit management system in accordance with an example embodiment of the present disclosure;

FIG. 2 illustrates a block diagram of a server in accordance with an example embodiment of the present disclosure;

FIG. 3 illustrates an example interaction flow between a travel supplier portal, an administration module, and data sharing providers in accordance with an example embodiment of the present disclosure;

FIG. 4 illustrates a process flow for managing company budgets and redeeming rewards in accordance with an example embodiment of the present disclosure;

FIGS. 5A-5B illustrate an exemplary user interface of a travel supplier portal in accordance with an example embodiment of the present disclosure;

FIG. 6 illustrates another exemplary user interface of the travel supplier portal in accordance with an example embodiment of the present disclosure;

FIG. 7 illustrates another exemplary user interface of the travel supplier portal for creating allotments in accordance with one embodiment of the present disclosure;

FIG. 8 illustrates another exemplary user interface of the centralized travel benefit management system in accordance with an example embodiment of the present disclosure; and

FIG. 9 illustrates a flowchart showing a method for the centralized travel benefit management system in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a Loyalty Exclusive Award Personalization (LEAP) feature of a centralized travel benefit management system. Embodiments may be configured to receive, from at least one travel supplier, a set of one or more travel benefits for one or more travelers associated with one or more enterprises. Embodiments may be configured to store the received one or more travel benefits in a centralized ledger, wherein the centralized ledger is configured to maintain benefit status of the one or more travel benefits for the one or more travelers associated with the one or more enterprises. Embodiments may be configured to provide, via an administration module communicatively coupled to the at least one processor, an access to a travel manager to assign the one or more travel benefits to the one or more travelers within an enterprise of the one or more enterprises based at least on predefined allocation rules. Embodiments may be configured to combine the one or more travel benefits into a bundled benefit for at least one traveler from the one or more travelers.

Embodiments may be configured to determine, in real time and prior to a redemption event, whether the at least one traveler is authorized to use the bundled benefit based at least on traveler identification data, corporate eligibility rules, and supplier usage restrictions. Embodiments may be configured to send, via an application programming interface (API) module, the bundled benefit to a loyalty or merchandising system of the at least one travel supplier to present the bundled benefit to the at least one traveler, upon determining the at least one traveler is authorized to use the bundled benefit. Embodiments may be configured to determine whether the bundled benefit presented to the at least one traveler is redeemed by the at least one traveler. Embodiments may be configured to update the centralized ledger in real time upon determining the bundled benefit is redeemed by the at least one traveler, to synchronize the benefit status across the at least one travel supplier, the travel manager, and the at least one traveler.

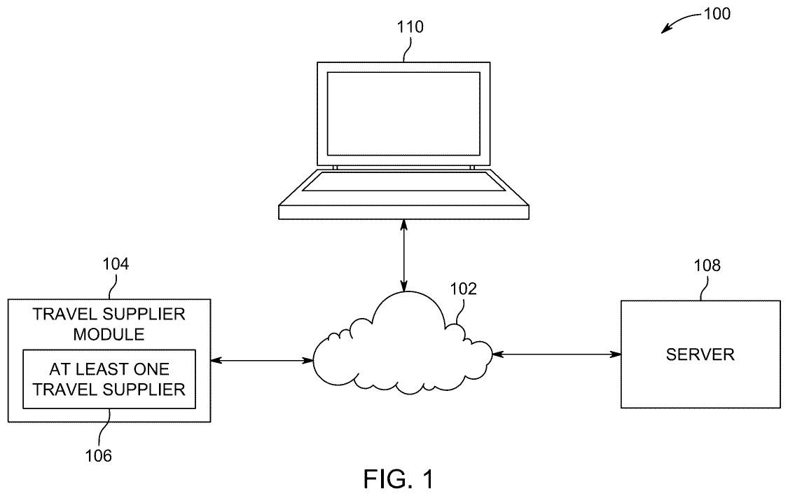

FIG. 1 illustrates a network diagram of a centralized travel benefit management system 100 in accordance with an example embodiment of the present disclosure. The centralized travel benefit management system 100 may comprise a network 102, a travel supplier module 104 for at least one travel supplier 106, and a server 108 communicatively coupled to the travel supplier module 104 via the network 102. Further, the centralized travel benefit management system 100 comprises at least one computing device 110 operationally installed with a travel benefit management platform.

In some embodiments, the network 102 may be a communication network such as internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the centralized travel benefit management system 100 may connect to the network 102 in accordance with various wired and wireless communication protocols such as Transmission Control Protocol and Internet Protocol (TCP/IP), One or more travelers Datagram Protocol (UDP), and 2G, 3G, or 4G communication protocols.

In some embodiments, the centralized travel benefit management system 100 may be referred to as a system 100. Further, the system 100 may comprise the travel supplier module 104. The travel supplier module 104 may be configured to manage communication and data exchange between the system 100 and one or more travel suppliers, such as airlines, hotels, car rental agencies, or other service providers. The travel supplier module 104 may receive information regarding available travel benefits, offers, and services from the at least one travel supplier 106 of the one or more travel suppliers and may provide such information to other components of the system 100, such as the server 108 or an administration module. In some embodiments, the travel supplier module 104 may be implemented using an application programming interface (API) module to enable secure, real-time, and automated data transfer. Additionally, the travel supplier module 104 may be configured to send booking requests, confirm reservations, update itineraries, and synchronize travel-related data to ensure that the traveler and the system 100 may remain updated with the most recent information from the at least one travel supplier 106.

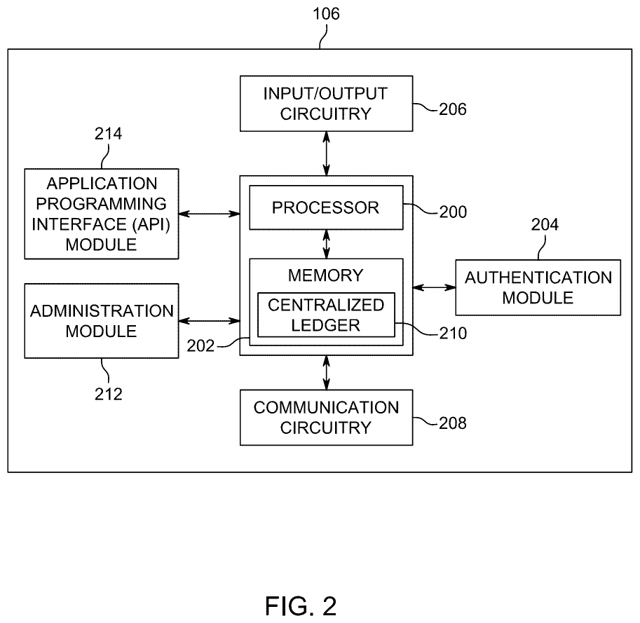

In some embodiments, the centralized travel benefit management system 100 may comprise the administration module (illustrated in FIG. 2). The administration module may be configured to facilitate configuration, monitoring, and management of travel benefit operations within the system 100. In some embodiments, the administration module may provide an interface accessible by authorized administrators to define rules, policies, and eligibility criteria for travel benefits, as well as to manage traveler profiles, approve benefit requests, and oversee integration with external travel supplier systems. The administration module may further enable role-based access control, and may allow different levels of permissions for various administrative at least one travelers. Further, the administration module may support analytics and reporting functionalities. Further, the administration module may enable the authorized administrators to track benefit utilization, compliance with organizational policies, and performance metrics of travel programs. In some embodiments, the administration module may interact with the API module to exchange data with external travel suppliers or ERP systems. Further, the API module may ensure accurate and up-to-date travel benefit information across all connected components of the system 100.

In some embodiments, the server 108 may be a computer or a software module that is configured to provide centralized resources, data, or services to the at least one computing device 110 operated by at least one at least one traveler. The server 108 may be configured to handle and manage one or more computational tasks and data processing within the system 100. In some embodiments, the server 108 may include storage systems, such as hard drives or storage arrays, to store and manage large volumes of data and information accessible to network at least one travelers. In some embodiments, the server 108 may further provide centralized control and management capabilities, allowing network at least one travelers to configure, monitor, and maintain network resources, security settings, and one or more travelers access permissions from a single location.

In some embodiments, the server 108 may comprise a memory, and at least one processor (illustrated in FIG. 2). The memory may have one or more computer readable instructions. The server 108 may be communicatively coupled to the memory. In some embodiments, the server 108 may be configured to receive, from at least one travel supplier 106 of the one or more travel suppliers, a set of one or more travel benefits for one or more travelers associated with one or more enterprises. The server 108 may be configured to communicate with the one or more travel suppliers to receive a set of the one or more travel benefits associated with the one or more travelers. The one or more travel benefits may include at least one of lounge passes, Wi-Fi vouchers, seat upgrades, priority boarding privileges, or loyalty reward points.

In some embodiments, upon receiving the one or more travel benefits, the server 108 may parse and validate associated metadata, such as benefit type, validity period, applicable routes, and redemption restrictions, to ensure compliance with predefined allocation rules. The received data may further include traveler-specific identification information, such as a name, loyalty account number, or corporate account identifier. The server 108 may correctly associate each travel benefit with the intended recipient. The validated travel benefits may then be stored in a centralized ledger within the system 100 for subsequent allocation, tracking, and redemption management. The configuration may allow seamless and secure ingestion of benefit data from the one or more travel suppliers into a unified management platform.

In some embodiments, the server 108 may be further configured to store the received one or more travel benefits in a centralized ledger. The centralized ledger may be configured to provide a unified and structured repository for managing all benefit-related data, and may ensure accuracy, accessibility, and traceability across the system 100. The centralized ledger may be configured to maintain benefit status of the one or more travel benefits comprising at least one of granted, assigned, redeemed, or expired. The centralized ledger may be further configured to store and track a usage history of each of the one or more travelers, including at least one of redeemed benefits, redemption dates, redemption channels, and remaining benefit entitlements. Further, the one or more travel benefits comprise at least one of lounge access passes, in-flight Wi-Fi vouchers, seat upgrades, priority boarding privileges, or loyalty points.

In some embodiments, the server 108 may be further configured to provide, via the administration module, access to a travel manager to assign the one or more benefits to the one or more travelers within an enterprise based on predefined allocation rules. The assignment may be performed based on predefined allocation rules, which may include parameters such as traveler role, seniority, travel frequency, or budgetary constraints. The administration module may further facilitate modifications to benefit allocations, maintain an audit trail of all assignments, and ensure that the allocation process aligns with the enterprise's travel policies.

In some embodiments, the server 108 may be further configured to allow the travel manager to combine the one or more travel benefits into a bundled benefit by grouping multiple benefit types together under an allocation rule of the predefined allocation rules. The allocation rule may comprise at least one of first-come-first-served distribution, traveler seniority-based distribution, travel frequency-based distribution, or route-specific allocation. Such the one or more travel benefits into a bundled benefit may allow the travel manager to combine diverse benefit categories such as seat upgrades, lounge access, excess baggage allowance, meal vouchers, or priority boarding into a single package that can be allocated in accordance with enterprise policies. The bundled benefit may streamline benefit distribution, reduce manual administrative effort, and ensure a transparent, fair, and policy-compliant allocation process. Furthermore, the system 100 may facilitate tracking and reporting of usage of the bundled benefit, allowing the enterprise to analyze distribution patterns, optimize benefit configurations, and enhance traveler satisfaction while maintaining budgetary control.

In some embodiments, the server 108 may be further configured to determine, in real time and prior to a redemption event, whether the at least one traveler is authorized to use the bundled benefit based on traveler identification data, corporate eligibility rules, and supplier usage restrictions stored in a database. The traveler identification data may comprise at least a traveler name, email address, employee identification number, department code, corporate policy tier, and loyalty account number. By cross-referencing the data against the corporate eligibility rules and supplier-specific restrictions, the server 108 may ensure that the bundled benefit are only accessible to authorized travelers in compliance with enterprise policies and contractual agreements.

In some embodiments, the server 108 may be further configured to authenticate the one or more travelers using a single sign-on mechanism, the single sign-on mechanism performing multi-factor authentication comprising cryptographic token validation and dynamic session allocation for secure access to the supplier's booking platform. In some embodiments, the SSO mechanism may perform multi-factor cryptographic token validation and dynamic session allocation for a secure access to a unified travel booking interface of the travel benefit management platform.

In some embodiments, the server 108 may be further configured to send the bundled benefit to a loyalty or merchandising system of the at least one travel supplier 106 to present the eligible one or more benefits to the at least one traveler within the travel benefit management platform. The server 108 may be further configured to integrate, via the API module, with a loyalty or merchandising system of the at least one travel supplier 106 to facilitate the retrieval and presentation of eligible benefits for the at least one traveler. The API module may enable secure, real-time communication between the server 108 and the supplier's system to obtain benefit data, such as loyalty rewards, promotional offers, or special upgrades, based on the traveler's profile and eligibility. The retrieved benefits may then be processed and displayed within the travel benefit management platform, and may allow the traveler to view, select, and redeem the applicable benefits in an efficient and at least one traveler-friendly manner.

In some embodiments, the server 108 may be further configured to present the one or more travel benefits to the at least one traveler during a booking process on the travel benefit management platform, such that the redemption occurs without requiring the at least one traveler to enter a benefit code. The configuration may allow the eligible benefits to be automatically applied or redeemed without requiring the traveler to manually enter a benefit code, and may streamline the redemption process, improve at least one traveler convenience, and may reduce the likelihood of errors or missed opportunities for benefit utilization. In some embodiments, the server 108 may be further configured to determine whether the bundled benefit presented to the at least one traveler is redeemed by the at least one traveler.

In some embodiments, the server 108 may be further configured to update the centralized ledger in real time upon redemption of the bundled benefit from the one or more benefits to synchronize the benefit status across the at least one travel supplier, the travel manager, and the at least one traveler. The real-time update may ensure that the benefit status is accurately synchronized and reflected across all relevant parties, including the at least one travel supplier, the travel manager, and the at least one traveler, and may maintain consistency of information, preventing duplicate redemptions, and enabling seamless coordination between all stakeholders in the travel benefit management process.

In some embodiments, the server 108 may be further configured to prevent an unauthorized use of the bundled benefit by enforcing one or more security mechanisms comprising at least one of encrypted traveler identification mapping, single-account locking, and real-time status validation. The server 108 may be further configured to ensure that the one or more travel benefits may be used exclusively within the authorized enterprise by employing one or more security mechanisms. The security mechanisms may include encrypted traveler identification mapping to securely associate benefits with the correct traveler, single-account locking to prevent multiple unauthorized accounts from accessing the same benefit, and real-time status validation to verify the eligibility and availability of a benefit at the time of use.

In some embodiments, the one or more service providers may be displayed on the at least one computing device 110. The at least one computing device 110 comprises a graphical at least one traveler interface (GUI) i.e. travel benefit management program that provides a at least one traveler-friendly platform for the at least one traveler to enter the login credentials and interact with the system 100. The GUI may be web-based, accessed through a browser, or through a dedicated software application installed on desktop computers, laptops, tablets, or smartphone. The at least one computing device 110 may be equipped by a at least one traveler or other service professionals responsible for managing the one or more service providers. In some embodiments, the at least one computing device 110 may include personal computers such as desktop computers, laptop computers, tablets, smartphones, or mobile devices.

It will be apparent to one skilled in the art that above-mentioned components of the system 100 have been provided only for illustration purposes, without departing from the scope of the disclosure.

FIG. 2 illustrates a block diagram of the server 108 in accordance with an example embodiment of the present disclosure.

In some embodiments, the server 108 may further comprise at least one processor 200, a memory 202, an authentication module 204, an input/output circuitry 206, and a communication circuitry 208. In some embodiments, the at least one processor 200 may be configured for executing the one or more computer readable instructions stored in the memory 202. In some embodiments, the at least one processor 200 may be configured to receive, from at least one travel supplier 106 of one or more travel suppliers, a set of one or more travel benefits for the one or more travelers associated with the enterprise. The at least one processor 200 may be configured to communicate with the at least one travel supplier 106 of the one or more travel suppliers to receive the set of the one or more travel benefits associated with the one or more travelers. The one or more travel benefits may include at least one of lounge passes, Wi-Fi vouchers, seat upgrades, priority boarding privileges, or loyalty reward points.

In some embodiments, upon receiving the one or more travel benefits, the at least one processor 200 may parse and validate associated metadata, such as benefit type, validity period of the one or more travel benefits, applicable routes, and redemption restrictions, to ensure compliance with the predefined allocation rules. The received data may further include traveler-specific identification information, such as a name, loyalty account number, or corporate account identifier, enabling the at least one processor 200 to correctly associate each travel benefit with the intended at least one traveler. The validated one or more travel benefits may then be stored in a centralized ledger 210 within the memory 202 for subsequent allocation, tracking, and redemption management. The storing of the one or more travel benefits in the centralized ledger 210 may allow seamless and secure ingestion of benefit data from the one or more travel suppliers into the system 100.

In some embodiments, the centralized ledger 210 may be configured to provide a unified and structured repository for managing all benefit-related data, and may ensure accuracy, accessibility, and traceability across the system 100. The centralized ledger 210 may be configured to maintain a status comprising at least one of granted, assigned, redeemed, or expired. The centralized ledger 210 may be further configured to store and track a usage history of each of the one or more travelers, including at least one of redeemed benefits, redemption dates, redemption channels, and remaining benefit entitlements. Further, the one or more travel benefits comprise at least one of lounge access passes, in-flight Wi-Fi vouchers, seat upgrades, priority boarding privileges, or loyalty points.

In some embodiments, the at least one processor 200 may be further configured to provide, via the administration module 212, access to a travel manager to assign the one or more benefits to the one or more travelers within the enterprise. In some embodiments, the one or more benefits are assigned to the one or more travelers based on predefined allocation rules. The one or more benefits are assigned to the one or more travelers based on predefined allocation rules. The one or more predefined allocation rules may include parameters such as traveler role, seniority, travel frequency, or budgetary constraints. The administration module 212 may further be configured to facilitate modifications to benefit allocations, maintain an audit trail of all assignments, and ensure that the allocation process aligns with the enterprise's travel policies.

In some embodiments, the at least one processor 200 may be further configured to allow the travel manager to combine the one or more travel benefits to into the bundled benefit. In some embodiments, the one or more travel benefits are combined by grouping multiple benefit types together under an allocation rule of the predefined allocation rules. The predefined allocation rules may comprise at least one of first-come-first-served distribution, traveler seniority-based distribution, travel frequency-based distribution, or route-specific allocation. The bundled benefit may allow the travel manager to combine diverse benefit categories such as seat upgrades, lounge access, excess baggage allowance, meal vouchers, or priority boarding into a single package that may be allocated in accordance with enterprise policies. The bundled benefit may streamline benefit distribution, reduce manual administrative effort, and ensure a transparent, fair, and policy-compliant allocation process. Furthermore, the system 100 may facilitate tracking and reporting of bundled benefit's usage, allowing the enterprise to analyze distribution patterns, optimize benefit configurations, and enhance traveler satisfaction while maintaining budgetary control.

In some embodiments, the at least one processor 200 may be configured to determine whether there are the one or more travel benefits or only a single benefit that is to be allocated to the at least one traveler. In one instance, the at least one processor 200 upon determining the one or more travel benefits, is configured to combine the one or more travel benefits into the bundled benefit. Further, in another instance, the at least one processor 200 upon determining only the single benefit of the one or more benefits to be allocated to the at least one traveler, the at least one processor 200 may not combine the single benefit.

In some embodiments, the at least one processor 200 may be further configured to determine, in real time and prior to a redemption event, whether the at least one traveler is authorized to use the bundled benefit. In some embodiments, the at least one processor 200 is configured to determine the authorization to use the bundled benefit based on traveler identification data, corporate eligibility rules, and supplier usage restrictions stored in a database. The traveler identification data may comprise at least a traveler name, email address, employee identification number, department code, corporate policy tier, and loyalty account number. By cross-referencing the traveler identification data against the corporate eligibility rules and supplier-specific restrictions, the server 108 may ensure that the one or more travel benefits are only accessible to authorized travelers in compliance with enterprise policies and contractual agreements.

In some embodiments, the at least one processor 200, via the authentication module 204, may be further configured to authenticate the one or more travelers using a single sign-on (SSO) mechanism. In some embodiments, the authentication module 204, using the single sign-on mechanism, is configured to perform multi-factor authentication using the authentication module 204. In some embodiments, the multi-factor authentication comprises cryptographic token validation and dynamic session allocation for secure access to the supplier's booking platform. In some embodiments, the SSO mechanism may perform multi-factor cryptographic token validation using the ERP database and dynamic session allocation for a secure access to a unified travel booking interface of the travel benefit management platform.

In some embodiments, the at least one processor 200 may be further configured to send, via the API module 214, the bundled benefit a merchandising system of the at least one travel supplier 106 to present the eligible one or more benefits to the at least one traveler within the travel benefit management platform. The at least one processor 200 is configured to send the bundled benefit by integrating, via the API module 214, the merchandising system of the at least one travel supplier 106 with the administration module 212. The API module 214 may enable secure, real-time communication between the at least one processor 200 and the at least one travel supplier's system to obtain benefit data, such as loyalty rewards, promotional offers, or special upgrades, based on the traveler's profile and eligibility. The bundled benefit may then be processed and displayed within the travel benefit management platform, and may allow the traveler to view, select, and redeem the applicable benefits in an efficient and at least one traveler-friendly manner.

In some embodiments, the at least one processor 200 may be further configured to present the bundled benefit to the at least one traveler during a booking process on the travel benefit management platform. In some embodiments, the bundled benefit are presented such that the redemption occurs without requiring the at least one traveler to enter a benefit code. The configuration may allow the bundled benefit to be automatically applied or redeemed without requiring the traveler to manually enter a benefit code. Further, the bundled benefit presented may streamline the redemption process, improve at least one traveler convenience, and may reduce the likelihood of errors or missed opportunities for benefit utilization.

In some embodiments, the at least one processor 200 may be further configured to determine whether the bundled benefit presented to the at least one traveler is redeemed by the at least one traveler. Further, the at least one processor 200 may be further configured to update the centralized ledger 210 in real time upon determining that the bundled benefit is redeemed by the at least one traveler. The centralized ledger 210 is updated to synchronize the status across the one or more travel suppliers, the travel manager, and the at least one traveler. The real-time update may ensure that the status is accurately synchronized and reflected across all relevant parties, including the at least one travel supplier, the travel manager, and the at least one traveler. Further, the updated centralized ledger 210 may maintain consistency of information, preventing duplicate redemptions, and enabling seamless coordination between all stakeholders in the travel benefit management process.

In some embodiments, the at least one processor 200 may be further configured to prevent the unauthorized use of the bundled benefit outside the authorized enterprise by enforcing one or more security mechanisms. The one or more security mechanisms comprises at least one of encrypted traveler identification mapping, single-account locking, and real-time status validation. The at least one processor 200 may be further configured to ensure that the bundled benefit may be used exclusively within the authorized enterprise by employing one or more security mechanisms. The one or more security mechanisms may include encrypted traveler identification mapping to securely associate benefits with the correct traveler, single-account locking. Further the encrypted traveler identification mapping may prevent multiple unauthorized accounts from accessing the same benefit, and real-time status validation to verify the eligibility and availability of a benefit at the time of use.

The at least one processor 200 may include suitable logic, circuitry, and/or interfaces that are operable to execute the one or more computer readable instructions stored in the memory 202 to perform predetermined operations. In some embodiments, the at least one processor 200 may be configured to store authorization data, booking-related transaction records, the one or more traveler's registration information, and the data visualizations in the memory 202 communicatively coupled to the at least one processor 200. In one embodiment, the at least one processor 200 may be configured to decode and execute any instructions received from one or more other electronic devices or server(s). The at least one processor 200 may be configured to execute one or more computer-readable program instructions, such as program instructions to carry out any of the functions described in this description. Examples of the at least one processor 200 include, but are not limited to, one or more general purpose processors and/or one or more special purpose processors.

In some embodiments, the memory 202 may be configured to store a set of instructions and data executed by the at least one processor 200. Further, the memory 202 may include the one or more instructions that are executable by the at least one processor 200 to perform specific operations associated with the centralized travel benefit management system 100. The memory 202 may be configured to store traveler authorization records, booking transaction details, allocation rules, bundled benefit, and usage history data received from the administration module or travel supplier module 104. The memory 202 may be configured to store traveler profile information, which may comprise at least one of a traveler name, email ID, employee ID, department, corporate policy tier, loyalty account number, discount code, and project code.

In some embodiments, the memory 202 may be configured to include the instructions for synchronizing an ERP database associated with the enterprise and a service provider database associated with the at least one travel supplier 106 in real time via the API module 214 The memory 202 may include instructions for authorizing access to the travel benefit management platform and enabling the one or more travelers to view, select, and redeem eligible travel benefits without requiring benefit codes. Further, the memory 202 may be configured to store the enterprise-specific parameters and instructions for enforcing predefined allocation rules, presenting personalized benefit bundles, and dynamically updating the centralized ledger 210 with status and usage history across the at least one travel supplier, the travel manager, and the traveler.

It is apparent to a person with ordinary skill in the art that the one or more computer readable instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the system 100 may further comprise an input/output circuitry 206. The input/output circuitry 206 may enable a at least one traveler, such as a traveler, travel manager, or the at least one travel supplier 106, to communicate or interface with the system 100 via the at least one computing device 110 or an administrative interface. The at least one computing device 110 may include N number of devices corresponding to different at least one travelers affiliated with the enterprise, including desktop computers, laptops, tablets, or mobile devices. In some embodiments, the input/output circuitry 206 may act as a medium to transmit and receive data between the system 100 and its connected components, including the travel benefit management platform, the administration module, and the travel supplier module 104. In some embodiments, the input/output circuitry 206 may refer to the hardware and software components that facilitate bidirectional data exchange, including traveler identification data, benefit selection inputs, redemption confirmations, allocation rule configurations, and usage history queries.

In one example, the server 108 may include a graphical at least one traveler interface (GUI) (not shown) as part of the input circuitry, which may allow travelers to view eligible travel benefits, redeem them during booking without entering benefit codes, and receive real-time confirmations. Travel managers may use the GUI to assign benefits, create bundles, or monitor benefit usage through dashboard visualizations. The input/output circuitry 206 may include various input components such as keyboards, touchscreens, and graphical widgets, enabling the at least one traveler to provide data such as traveler profile details, project codes, loyalty account numbers, or allocation parameters. In another example, the input/output circuitry 206 may include various output components such as displays, notification systems, and report generators to convey information including real-time status, booking confirmations, allocation summaries, and enterprise-specific travel analytics. The input/output circuitry 206 may further facilitate integration with external systems via the API module to exchange benefit data, traveler information, and transaction updates with the loyalty or merchandising system of the at least one travel supplier.

In some embodiments, the server 108 may further comprise a communication circuitry 208. The communication circuitry 208 may allow the server 108 to exchange data or information with external systems, including the centralized ledger 210, the ERP database, the travel supplier systems, and the travel benefit management platform. Further, the communication circuitry 208 may include network interfaces, protocols, and software modules responsible for sending and receiving benefit-related data, traveler identification information, allocation configurations, and redemption records. In some embodiments, the communication circuitry 208 may include Ethernet ports, Wi-Fi adapters, or communication protocols such as HTTP, HTTPS, or MQTT for connecting with other enterprise and supplier systems.

The communication circuitry 208 may further include components such as communication modules (e.g., Wi-Fi, Ethernet, cellular), transceivers, antennas, and protocols (e.g., TCP/IP, REST, SNMP) for enabling secure and real-time data exchange. These components may facilitate interaction with the API module, allowing the at least one processor 200 to transmit traveler identification data, eligible benefits, booking details, and usage history between the travel benefit management platform and the loyalty or merchandising systems of travel suppliers. Further, the communication circuitry 208 may ensure that real-time synchronization of statuses, allocation rules, and redemption events is secure, reliable, and efficient across the at least one travel supplier, the travel manager, and the traveler. The communication circuitry 208 may also enable the at least one processor 200 to maintain continuous connectivity with enterprise modules to dynamically enforce benefit entitlements, usage restrictions, and policy compliance based on corporate rules.

It will be apparent to one skilled in the art the above-mentioned components of the server 108 have been provided only for illustration purposes, without departing from the scope of the disclosure.

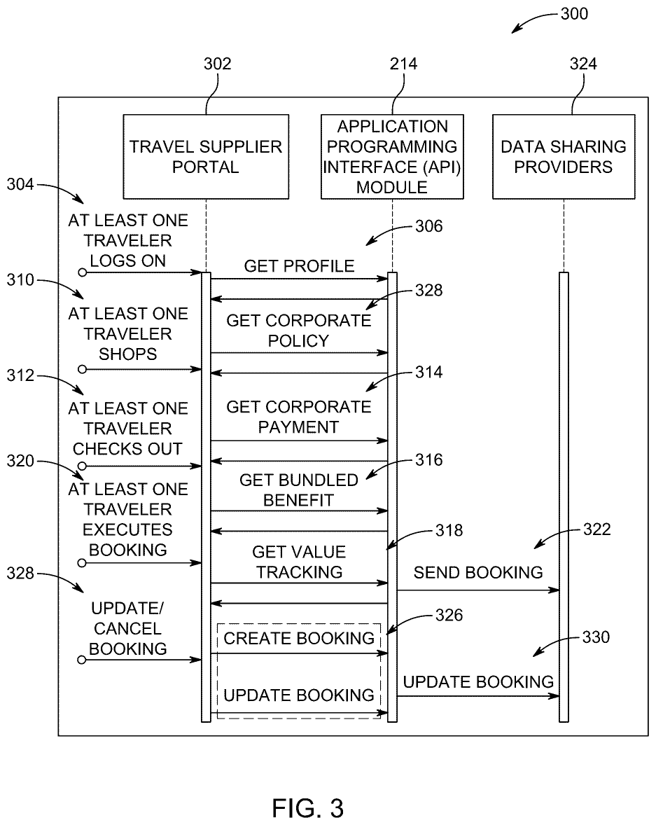

FIG. 3 illustrates an example interaction flow 300 between a travel supplier portal 302, the administration module 212, and data sharing providers 324 in accordance with an example embodiment of the present disclosure.

At operation 304, the at least one traveler logs on to the travel supplier portal 302. The login action may establish an authenticated at least one traveler session and may trigger any configured authentication flows (for example, single sign-on via an identity provider) using the authentication module 204. The login action may establish the context needed for the at least one travel supplier 106 to request corporate and traveler-specific data from the server 108.

In some embodiments, the travel supplier portal 302 refers to a digital interface, such as a web-based or application-based platform, provided by the at least one travel supplier 106 (e.g., airline, hotel, car rental agency). The travel supplier portal 302 enables authorized at least one travelers to access supplier services, manage benefit allocations, and facilitate secure communication between the travel supplier portal and the centralized travel benefit management system 100.

At operation 306, the travel supplier portal 302 may issue a get profile request to the administration module 212 via the API module 214. In response, the administration module 212 may retrieve and return the at least one traveler's profile information. In one example, at least one traveler's profile information may include traveler registration data, corporate affiliation, loyalty identifiers, cached preferences, and any previously-assigned bundle benefit. The at least one traveler's profile information may be used by the travel supplier portal 302 to tailor the shopping and booking experience to the authenticated traveler.

At operation 308, the travel supplier portal 302 may request the administration module 212 by the API module 214 to get enterprise travel rules by issuing a get corporate policy request to the server 108. The server 108 using the administration module 212 may consult stored enterprise policy parameters (such as permitted carriers, fare classes, approval thresholds, and team-level restrictions) and may return the relevant corporate policy data to the travel supplier portal 302. The travel supplier portal 302 may filter, highlight, or block travel options that do not comply with the company's rules.

At operation 310, the at least one traveler of the one or more travelers proceeds to shop into the travel supplier portal 302. In some embodiments, a shopping interaction into the travel supplier portal 302 may include browsing and selecting travel services such as flights, ancillary products, upgrades, or bundled benefit that are made available by the at least on travel supplier 106. During the shopping interaction, the travel supplier portal 302 dynamically retrieves eligibility information and available bundled benefit associated with the at least one traveler, which are stored in the centralized ledger 210 and synchronized through the API module 214.

At operation 312, the at least one traveler of the one or more travelers proceeds toward checkout from the travel supplier portal 302. Further, at operation 314, the travel supplier portal 302 may issue a get corporate payment request to the server 108, upon checking out of the travel supplier portal 302. The server 108 may validate corporate payment entitlements and may return the appropriate corporate payment credential or routing instruction to the travel supplier portal 302. The server 108 may return the appropriate corporate payment credential or routing instruction so that booking may be charged in accordance with enterprise billing policies.

At operation 316, the travel supplier portal 302 may issue a get bundled benefit request to the server 108. The server 108 may consult the centralized ledger 210 and administration module 212 to determine which bundled benefit may be granted or assigned to the at least one traveler of the one or more travelers or available to the at least one traveler's enterprise. Further, the server 108 may return the set of eligible attributes and any applicable usage restrictions for display or automatic application.

At operation 318, the travel supplier portal 302 may request get value tracking information from the server 108, when the at least one traveler executes a booking (as shown by an arrow 320). The value tracking data may represent metrics such as estimated negotiated savings, loyalty accruals, benefit consumption counts, or other financial/value indicators associated with the pending booking and the bundle benefit. Further, at step 322, the server 108 using the API module 214 is configured to send the booking to data sharing providers 324.

At operation 326, the travel supplier portal 302 may execute a create booking action, and an update booking action, and send the booking details to the server 108. The travel supplier portal 302 may execute the create booking action, and the update booking action when the at least one traveler updates or cancels the booking (as shown by an arrow 328). The server 108 may record the booking in the centralized ledger 210, update any associated statuses, and may create a canonical booking record for enterprise tracking.

In some embodiments, if the at least one traveler initiates a modification or cancellation via the travel supplier portal 302, the travel supplier portal 302 may issue an update booking request to the server 108. The request may contain the requested changes and may initiate the enterprise-side update workflow for the booking and any associated entitlements.

At operation 330, the server 108 may forward the updated booking information to the data sharing providers 324 with an update booking message, and may ensure that external enterprise systems and any partner services receive the change and may reconcile their records with the new booking status.

In some embodiments, the data sharing providers 324 may refer to third-party systems, platforms, or service entities that facilitate the secure exchange of corporate, traveler, or benefit-related data between the centralized travel benefit management system and external environments. The data sharing providers 324 may include, for example, identity management services, global distribution systems (GDS), travel management companies (TMCs), payment gateways, or other integration partners that enable authentication, entitlement verification, and synchronization of benefit usage. In some embodiments, data sharing providers 324 may expose standardized APIs or secure data pipelines that allow the at least one travel supplier 106, travel manager, and the centralized ledger 210 to exchange information in compliance with industry data-sharing standards, privacy regulations, and contractual requirements.

According to an example, a practical deployment of the centralized travel benefit management system 100, the at least one travel supplier 106 such as an airline provides one or more travel benefits, which may include lounge passes, complimentary seat upgrades, or in-flight Wi-Fi vouchers. The one or more benefits are transmitted from the at least one travel supplier's merchandising system 410 into the centralized travel benefit management system. Once received, the one or more benefits are recorded in the centralized ledger 210, which maintains the benefit status of each benefit as granted, assigned, redeemed, or expired. This ensures that all stakeholders, the at least one travel supplier 106, the travel manager, and the one or more travelers have a synchronized and transparent view of available benefits.

An enterprise subscribing to this service appoints the travel manager who accesses the administration module 212 of the system 100. The travel manager defines the at least on predefined allocation rules within the administration module 212. For example, the at least on predefined allocation rules may specify that business-class travelers receive lounge passes, frequent travelers with more than a certain number of trips per year receive complimentary upgrades, and international travelers are provided with Wi-Fi vouchers. The at least on predefined allocation rules ensure that distribution of the one or more benefits aligns with corporate policy and travel budgets, while still allowing flexibility for adjustments over time.

When an employee which the at least one traveler of the enterprise accesses the travel supplier portal 302 to shop for or book a flight, the system 100 automatically determines, in real time, whether that at least one traveler is eligible to redeem any of the stored one or more travel benefits or the bundled benefits. The determination is based on traveler identification data (such as employee ID linked to the enterprise), the corporate allocation rules, and any supplier usage restrictions stored in the system database. This check occurs before the redemption event, ensuring that only eligible benefits are presented to the traveler.

Through the API module 214, the travel supplier portal 302 integrates seamlessly with the system 100 to display the bundled benefits available to the at least one traveler. During the booking process, the eligible traveler is presented with the option to redeem benefits that match their travel profile and allocation eligibility. For instance, if the at least one traveler is booking an international trip, the system 100 may present an in-flight Wi-Fi voucher and a priority boarding pass as available options. The at least one traveler may select and redeem the benefits directly within the portal without requiring manual codes or external confirmations.

Once the redemption occurs, the centralized ledger 210 is updated in real time to reflect the consumed benefits. This update is automatically synchronized across the travel supplier's system, the corporate travel managers dashboard, and the traveler's personal view. The synchronization ensures that the at least one supplier 106 provisions the redeemed benefit (e.g., activating priority boarding), the travel manager monitors usage and remaining inventory, and the at least one traveler has a seamless experience without delays or confusion.

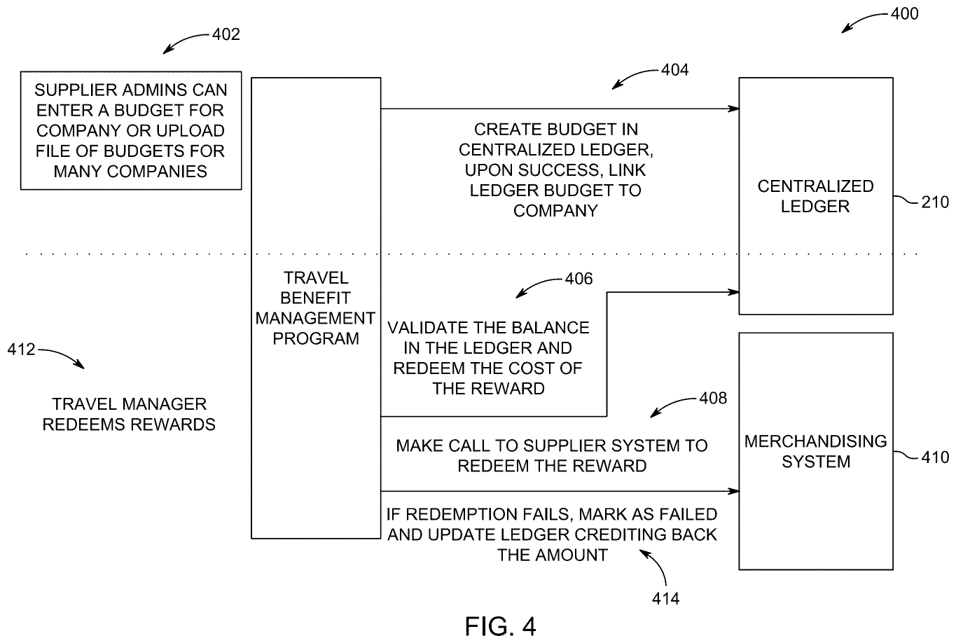

FIG. 4 illustrates a process flow 400 for managing company budgets and redeeming rewards in accordance with an example embodiment of the present disclosure.

At operation 402, the process flow 400 begin with the supplier administrators, who may either manually enter a budget for a specific company or upload a file containing multiple budgets for several companies.

In some embodiments, the supplier administrators may refer to designated personnel or automated system agents within the at least one travel supplier's organization (for example, airline loyalty managers, merchandising system operators, or other authorized staff) who are responsible for configuring, allocating, and overseeing the one or more travel benefits. The supplier administrators have privileged access to the travel supplier portal 302 or backend system and may perform functions such as creating company-specific budgets, uploading allocation files for multiple enterprises, managing the issuance of rewards, and monitoring redemption activity. In some embodiments, supplier administrators may also interface with the centralized travel benefit management system 100 through the API module 214 to ensure that budgets, entitlements, and benefit statuses are synchronized in real time across all stakeholders.

At operation 404, once the budget entry or upload is completed, the system 100 may initiate a process to create the budget in the centralized ledger 210. Upon successful creation, the budget in the centralized ledger 210 may be linked to the corresponding company, and may ensure secure and tamper-proof budget records.

Further, at operation 406, subsequently, when a corporate administrator initiates the redemption of rewards, the supplier administrator may first validate the balance available in the centralized ledger 210. The validation step may ensure that sufficient funds may be available to cover the cost of the intended bundled benefit. At operation 408, if the validation is successful, the supplier administrator may redeem the required cost from the centralized ledger 210 and may proceed to initiate a call to the travel supplier module 104 to enable the merchandising system 410 for reward redemption.

In some embodiments, at operation 412, the at least one travel manager is then responsible for processing the redemption request. If the reward redemption is successful, the process completes without further intervention. However, in cases where redemption fails, at operation 414, the system 100 may mark the transaction as failed. Further, the centralized ledger 210 may be updated to credit back the amount to the at least one travel manager, previously deducted, and may maintain accurate and real-time budget integrity.

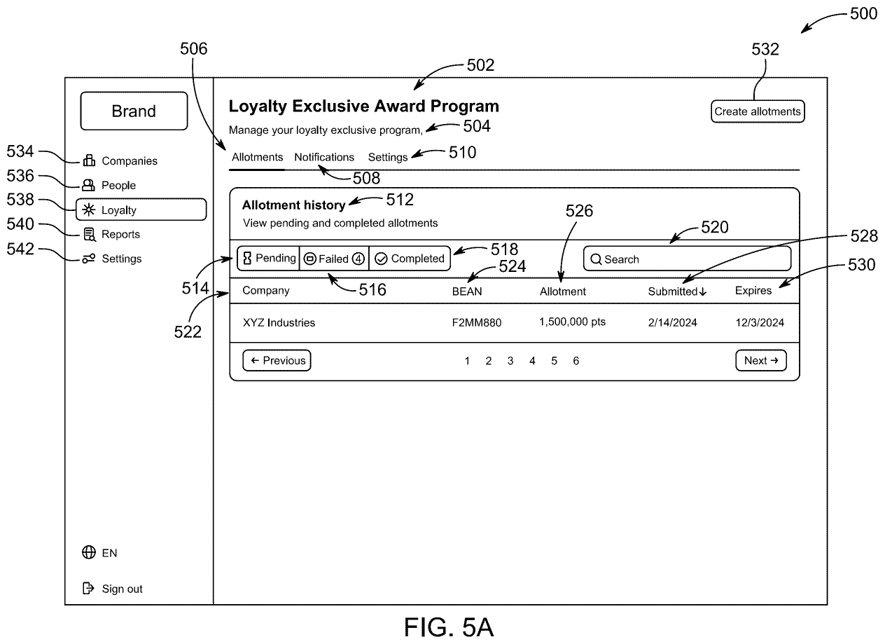

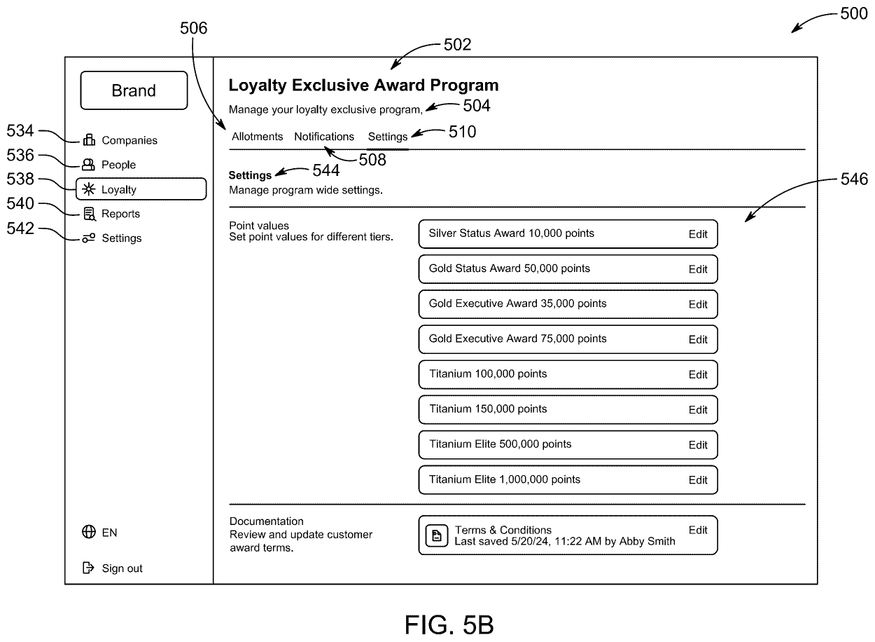

FIGS. 5A-5B illustrates an exemplary user interface 500 of the travel supplier portal 302 in accordance with an example embodiment of the present disclosure.

In some embodiments, a navigation panel is provided, containing selectable menu items brand, companies, people, loyalty, reports, and settings. The loyalty section may be currently active. In the central area, the screen header may display a title “Loyalty Exclusive Award Program” 502 along with the description “Manage your loyalty exclusive program” as shown by an arrow 504. Three tabs allotments 506, notifications 508, and settings 510 may be positioned directly below the header, with allotments currently selected.

In some embodiments, beneath the three tabs, there may be a section titled “allotment history” 512, accompanied by the subtext “view pending and completed allotments.” The section titled “allotment history” 512 may provide filter options in the form of three selectable status buttons: pending 514, failed 516 (with a count indicator “4”), and completed 518. A search bar 520 may also available for quickly locating specific allotments.

In some embodiments, the section titled “allotment history” 512 may contain columns labeled company 522, BEAN 524, allotment 526, submitted 528, and expires 530. In one example, there may be one listed allotment for “XYZ Industries” with a BEAN identifier “F2MM8B0,” an allotment of “1,500,000 pts,” a submission date of “Feb. 14, 2024,” and an expiration date of “Dec. 3, 2024.” Pagination controls labeled previous, numbered page indicators, and next may allow navigation through multiple pages of allotment records. In some embodiments, a create allotments button 532 may be visible in the top-right corner of the screen, and may enable the administrators to initiate the creation of new loyalty point allotments (i.e. the one or more travel benefits).

Further, on the navigation pane, other options may also be visible, the other options may comprise companies tab 534, people tab 536, loyalty tab 538 that shows the title “Loyalty Exclusive Award Program” 502, reports tab 540, settings tab 542. As shown in FIG. 5B, the navigation panel may contain the same set of options, with loyalty remaining highlighted. The central header again may display “loyalty exclusive award program” 502 along with the description “Manage your loyalty exclusive program” as shown by the arrow 504. The three tabs allotments 506, notifications 508, and settings 510 may be again present, with settings currently selected. Within the settings 510 tab, a setting section 544 may be presented, accompanied by the description “manage program wide settings.” Under the setting section 544, a point values category may be shown with the subtext “set point values for different tiers.” A list of tiered award types 546 may be displayed, each associated with a defined point value and an edit button for modifying the respective value. Examples in the illustrated embodiment may include Silver Status Award—10,000 points, Gold Status Award—50,000 points, Gold Executive Award—35,000 points, Gold Executive Award—75,000 points, Titanium—100,000 points, Titanium—150,000 points, Titanium Elite—500,000 points, and Titanium Elite—1,000,000 points.

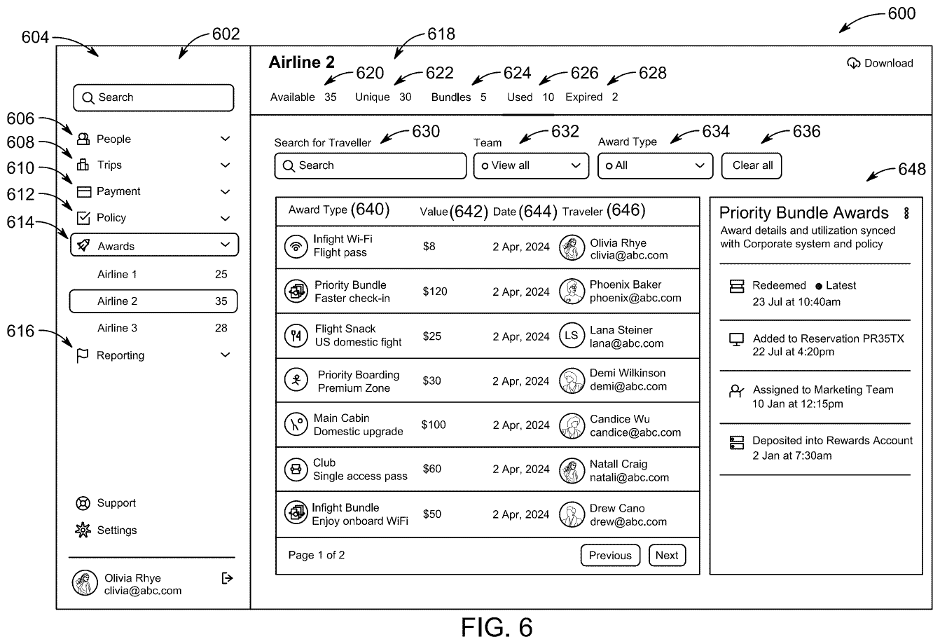

FIG. 6 illustrates another exemplary user interface 600 of the travel supplier portal 302 in accordance with an example embodiment of the present disclosure.

In some embodiments, in the left-hand panel of the GUI 600, a navigation menu 602 is displayed. The topmost portion of the navigation menu 602 may include a search bar 604 for quick navigation across system modules. Below the search bar 604, a vertical list of navigation categories may be provided, including People 606, Trips 608, Payment 610, Policy 612, Awards 614, and Reporting 616. The Awards 614 category may be expanded to display individual airline subcategories. Additional menu items at the bottom of the navigation panel may include Support and Settings.

In some embodiments, a central panel 618 of the GUI may display award details for the selected airline. At the top of the central panel, statistical counters may be shown for available awards 620 (35), unique award types 622 (30), bundles 624 (5), used awards 626 (10), and expired awards 628 (2). Below the statistical counters, filtering and search functionalities are provided, including a Search for traveler field 630, a team dropdown filter 632, and an award type dropdown filter 634. A clear all button 636 may be provided to remove applied filters.

In some embodiments, an awards list 638 (i.e. the one or more travel benefits) may be presented in a tabular format with the following columns: Award Type 640, Value 642, Date 644, and Traveler 646. Each row in the table may correspond to a specific award. The right-hand panel may provide award activity details for a selected award from the list.

In one example, the award type 640 may be “inflight Wi-Fi flight pass” having value of “8$”. Further, the “inflight Wi-Fi flight pass” may be allocated on 2 Apr. 2024, and is allocated to Ollvia Rhye having email id “Clivia@abc.com”. Further, on the right side of the awards list 638, priority bundle awards 640 may be shown.

The awards list 638 may display a chronological history of award-related events. In some embodiments, the GUI may allow direct interaction with the elements, enabling the administrators to filter award usage data, review award allocation across teams, track redemption history, and enforce corporate policy compliance. The interface may be integrated with the corporate system's policy engine and external airline APIs to ensure that the displayed information is synchronized in real time.

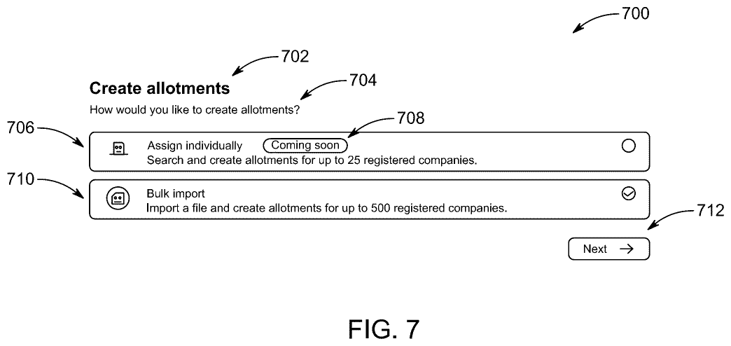

FIG. 7 illustrates another exemplary user interface 700 of the travel supplier portal 302 for creating allotments in accordance with one embodiment of the present disclosure.

In some embodiments, at the top of the GUI 700, a title “create allotments” 702 may be prominently displayed, indicating the purpose of the GUI screen. Directly beneath the title “create allotments” 702, a short instructional prompt “How would you like to create allotments?” 704 may be presented to guide the at least one traveler's selection process. Two primary options for allotment creation may be displayed in a stacked selection layout. An assign individually option 706 may be located at the top, and may allow the at least one traveler to search for and create allotments for up to 25 registered companies. However, the assign individually option 706 may be accompanied by the label “Coming soon” 708 in a small blue font, indicating that the functionality is not yet available for use. The assign individually option 706 may be visually presented in a light, inactive style to further signal its unavailability. In some embodiments, a bulk import option 710 may allow the at least one traveler to import a file and create allotments for up to 500 registered companies at once. It may be presented as the currently selected method, and may be indicated by a highlighted border and a filled selection circle on its left side. A description of the bulk import option 710 may be displayed in smaller text beneath the main label, clearly stating the capacity and functionality. The description may be “import a file and create allotments for up to 500 registered companies”.

In some embodiments, in the lower-right corner of the screen, a blue “Next” button 712 may be displayed, allowing the at least one traveler to proceed to the next step after selecting a creation method. The “Next” button 712 may include a right-facing arrow icon to visually communicate forward navigation. In some embodiments, the interface may further integrate with backend processing modules to handle uploaded bulk allotment files, validate their format, and automatically distribute the specified allotments to registered companies. The design of the interface prioritizes ease of use, offering a choice between manual, smaller-scale allotment assignment and larger-scale automated bulk uploads.

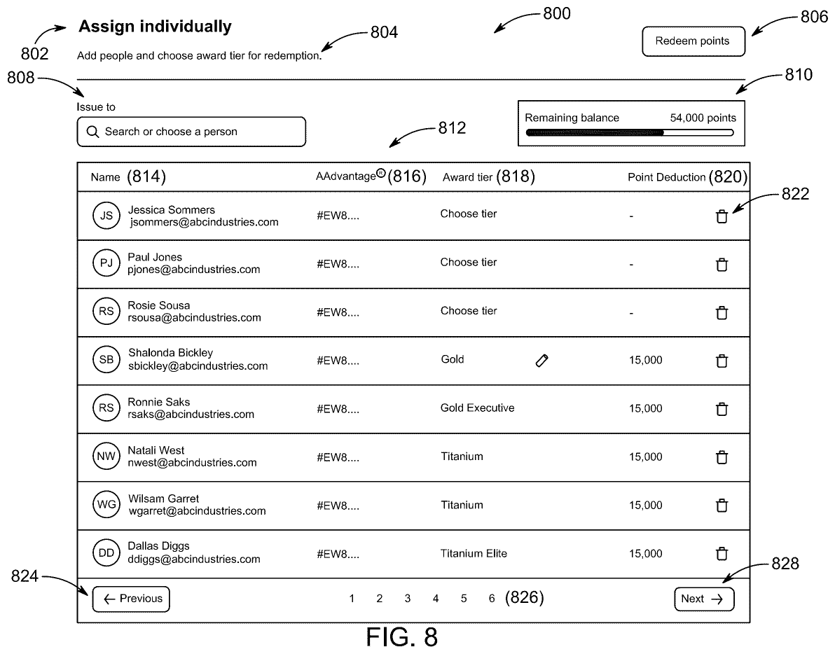

FIG. 8 illustrates another exemplary user interface 800 of the centralized travel benefit management system 100 in accordance with an example embodiment of the present disclosure.

At the top of the interface, the heading “assign individually” 802 is prominently displayed, indicating the purpose of the page. Directly beneath, an instructional line “Add people and choose award tier for redemption” 804 may guide the at least one traveler on the action to be taken. On the far right side of this top section, a blue button labeled “Redeem points” 806 allows the at least one traveler to confirm and process the allocation once selections are made. A search field labeled “Issue to” 808 may be provided to enable the administrator to quickly search for or choose a person from the database. Beneath the search field, a “Remaining balance” 810 bar may be displayed, showing the total points available for allocation.

In some embodiments, the main section of the interface may consist of a table 812 with five columns. The column may include name 814, advantage 816, award tier 818, point deduction 820, and delete button 822. Pagination controls are located at the bottom of the interface, allowing the administrator to navigate through multiple pages of recipients. A “Previous” button 824 is on the left, numbered page buttons 826 may be displayed in the center, and a “Next” button 828 is positioned on the right for moving forward. In certain embodiments, the server 108 dynamically calculates and displays the updated remaining point balance based on selected award tiers and their corresponding point deductions. The interface 800 may further show available balance before allowing redemption, ensuring that allocations do not exceed the total available points.

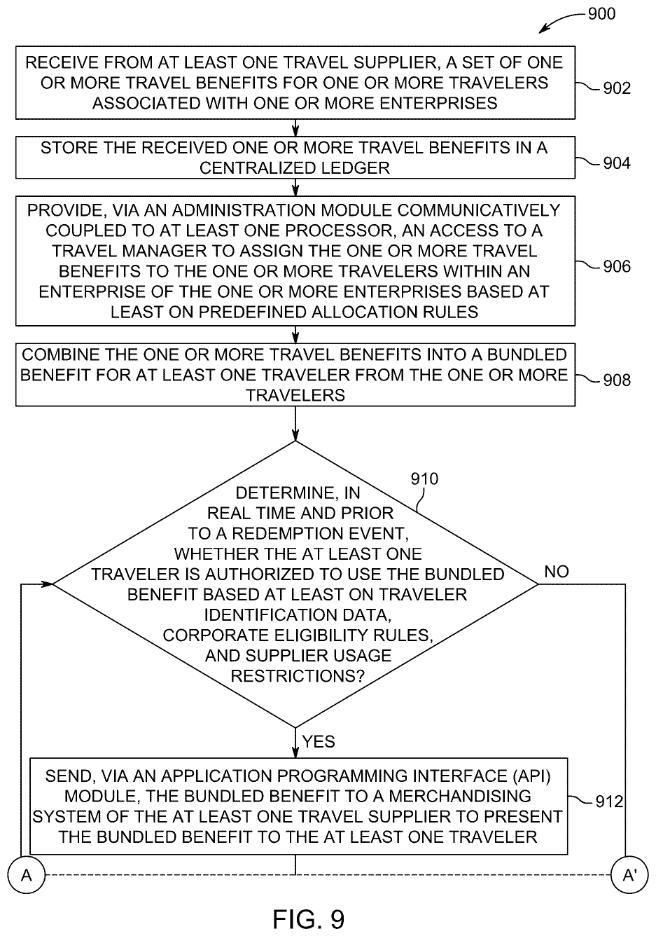

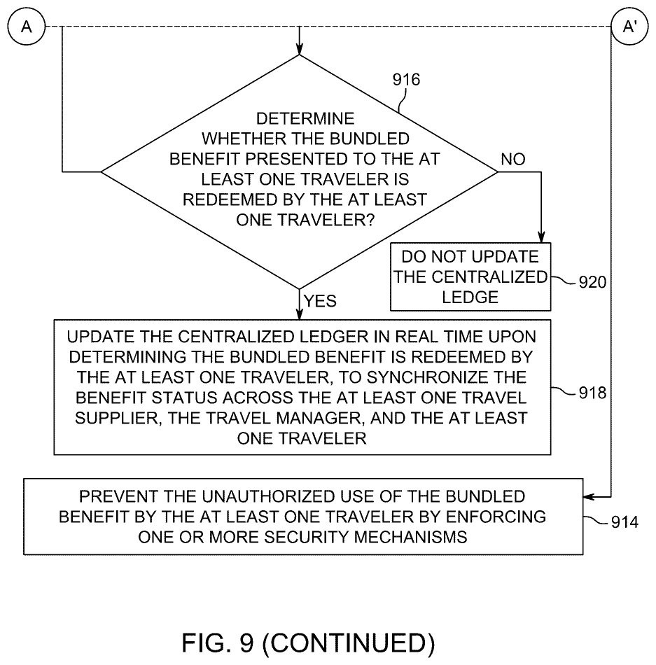

FIG. 9 illustrates a flowchart showing a method for the centralized travel benefit management system 100 in accordance with an example embodiment of the present disclosure.

At operation 902, the at least one processor 200 receives from at least one travel supplier, a set of one or more travel benefits for one or more travelers associated with one or more enterprises. In some embodiments, the one or more travel benefits comprise at least one of lounge access passes, in-flight Wi-Fi vouchers, seat upgrades, priority boarding privileges, or loyalty points.

At operation 904, the at least one processor 200 stores the received one or more travel benefits in the centralized ledger 210. In some embodiments, the centralized ledger 210 is configured to maintain benefit status of the one or more travel benefits for the one or more travelers associated with the one or more enterprises.

In some embodiments, the benefit status of the one or more travel benefits comprises at least one of granted benefits, assigned benefits, redeemed benefits, or expired benefits for each traveler associated with the one or more enterprises.

At operation 906, the at least one processor 200 provides, via the administration module 212 communicatively coupled to the at least one processor 200, an access to the travel manager to assign the one or more travel benefits to the one or more travelers within an enterprise of the one or more enterprises based at least on predefined allocation rules.

In some embodiments, the predefined allocation rules comprises at least one of first-come-first-served distribution, traveler seniority-based distribution, travel frequency-based distribution, or route-specific allocation.

In some embodiments, the predefined allocation rules are stored in the memory 202 communicatively coupled to the at least one processor 200, and dynamically applied by the administration module 212 to assign the one or more travel benefits.

At operation, 908, the at least one processor 200 combines the one or more travel benefits into the bundled benefit for at least one traveler from the one or more travelers. It may be noted that the at least one processor 200 may be configured to determine if the at least one traveler is having more than one travel benefits from the one or more travel benefits. If there are more than one travel benefits from the one or more travel benefits, the system 100 is directed to the operation 908. Further, if there is no more than one travel benefits from the one or more travel benefits, the system 100 directly proceeds to the operation 910.

At operation, 910, the at least one processor 200 determines, in real time and prior to a redemption event, whether the at least one traveler is authorized to use the bundled benefit based at least on traveler identification data, corporate eligibility rules, and supplier usage restrictions. In some embodiments, the traveler identification data comprises at least one of a traveler's name, an email address, an employee identification number, a department code, a corporate policy tier, and a loyalty account number.

At operation, 912, the at least one processor 200 sends, via the application programming interface (API) module 214, the bundled benefit to the merchandising system 410 of the at least one travel supplier 106 to present the bundled benefit to the at least one traveler, upon determining the at least one traveler is authorized to use the bundled benefit. Further, the system 100 directs to operation 914, upon determining the at least one traveler is not authorized to use the bundled benefit.

At the operation 914, the at least one processor 200 prevent the unauthorized use of the bundled benefit by the at least one traveler by enforcing one or more security mechanisms, upon determining the at least one traveler is not authorized to use the bundled benefit. In some embodiments, the one or more security mechanisms comprises at least one of encrypted traveler identification mapping, single-account locking, and real-time benefit status validation.

At the operation 916, the at least one processor 200 determines whether the bundled benefit presented to the at least one traveler is redeemed by the at least one traveler.

At the operation 918, the at least one processor 200 updates the centralized ledger 210 in real time upon determining the bundled benefit is redeemed by the at least one traveler, to synchronize the benefit status across the at least one travel supplier, the travel manager, and the at least one traveler. However, the system 100 directs to step 920, where the at least one processor 200 does not updates the centralized ledger 210, upon determining the bundled benefit is not redeemed by the at least one traveler.

In some embodiments, the centralized ledger 210 is further configured to store and track a usage history of each of the one or more travelers, including at least one of redeemed benefits, redemption dates, redemption channels, and remaining benefit entitlements.

The centralized travel benefit management system 100 of the present disclosure offers significant advantages over conventional travel program management approaches. By consolidating travel authorization, provider selection, booking integration, and expenditure tracking into a unified platform, the system 100 eliminates the need for multiple disjointed tools and manual reconciliation processes. The ERP-based authorization and context-aware provider selection reduce approval delays and ensure cost-effective travel decisions. The API-based linking with service provider systems streamlines booking and fulfillment while maintaining real-time synchronization of itineraries and expenses. Furthermore, the integrated analytics and visualization tools provide actionable insights for organizations to monitor travel trends, optimize budgets, and enhance policy compliance. The secure single sign-on (SSO) authentication further improves usability and data security, allowing travelers, managers, and administrators to access relevant travel data with minimal friction. Collectively, such advantages result in improved operational efficiency, reduced travel costs, and enhanced at least one traveler satisfaction.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A centralized travel benefit management system comprising:
a memory having one or more computer readable instructions;
at least one processor communicatively coupled with the memory, wherein the at least one processor executing the one or more computer readable instructions stored in the memory is configured to:
receive, from at least one travel supplier, a set of one or more travel benefits for one or more travelers associated with one or more enterprises;
store the received one or more travel benefits in a centralized ledger, wherein the centralized ledger is configured to maintain benefit status of the one or more travel benefits for the one or more travelers associated with the one or more enterprises;
provide, via an administration module communicatively coupled to the at least one processor, an access to a travel manager to assign the one or more travel benefits to the one or more travelers within an enterprise of the one or more enterprises based at least on predefined allocation rules;
combine the one or more travel benefits into a bundled benefit for at least one traveler from the one or more travelers;
determine, in real time and prior to a redemption event, whether the at least one traveler is authorized to use the bundled benefit based at least on traveler identification data, corporate eligibility rules, and supplier usage restrictions;
send, via an application programming interface (API) module, the bundled benefit to a merchandising system of the at least one travel supplier to present the bundled benefit to the at least one traveler, upon determining the at least one traveler is authorized to use the bundled benefit;
determine whether the bundled benefit presented to the at least one traveler is redeemed by the at least one traveler; and
update the centralized ledger in real time upon determining the bundled benefit is redeemed by the at least one traveler, to synchronize the benefit status across the at least one travel supplier, the travel manager, and the at least one traveler.

2. The centralized travel benefit management system of claim 1, wherein the at least one processor executing the one or more computer readable instructions stored in the memory is further configured to prevent an unauthorized use of the bundled benefit by the at least one traveler by enforcing one or more security mechanisms, upon determining the at least one traveler is not authorized to use the bundled benefit.

3. The centralized travel benefit management system of claim 2, wherein the one or more security mechanisms comprises at least one of encrypted traveler identification mapping, single-account locking, and real-time benefit status validation.

4. The centralized travel benefit management system of claim 1, wherein the traveler identification data comprises at least one of a traveler's name, an email address, an employee identification number, a department code, a corporate policy tier, and a loyalty account number.

5. The centralized travel benefit management system of claim 1, wherein the centralized ledger is further configured to store and track a usage history of each of the one or more travelers, including at least one of redeemed benefits, redemption dates, redemption channels, and remaining benefit entitlements.

6. The centralized travel benefit management system of claim 1, wherein the benefit status of the one or more travel benefits comprises at least one of granted benefits, assigned benefits, redeemed benefits, or expired benefits for each traveler associated with the one or more enterprises.

7. The centralized travel benefit management system of claim 1, wherein the predefined allocation rules comprises at least one of first-come-first-served distribution, traveler seniority-based distribution, travel frequency-based distribution, or route-specific allocation.

8. The centralized travel benefit management system of claim 1, wherein the predefined allocation rules are stored in the memory communicatively coupled to the at least one processor, and dynamically applied by the administration module to assign the one or more travel benefits.

9. The centralized travel benefit management system of claim 1, wherein the at least one processor executing the one or more computer readable instructions stored in the memory is further configured to authenticate the one or more travelers using a single sign-on mechanism during the redemption event, wherein the single sign-on mechanism is configured to perform multi-factor authentication comprising cryptographic token validation and dynamic session allocation for secure access to at least one travel supplier's booking platform.

10. The centralized travel benefit management system of claim 1, wherein the one or more travel benefits comprise at least one of lounge access passes, in-flight Wi-Fi vouchers, seat upgrades, priority boarding privileges, or loyalty points.

11. A method comprising:
receiving, via at least one processor communicatively coupled with a memory, a set of one or more travel benefits for one or more travelers associated with one or more enterprises, from at least one travel supplier;
storing, via the at least one processor, the received one or more travel benefits in a centralized ledger, wherein the centralized ledger is configured to maintain benefit status of the one or more travel benefits for the one or more travelers associated with the one or more enterprises;
providing, via an administration module communicatively coupled to the at least one processor, an access to a travel manager to assign the one or more travel benefits to the one or more travelers within an enterprise of the one or more enterprises based at least on predefined allocation rules;
combining, via the at least one processor, the one or more travel benefits into a bundled benefit for at least one traveler from the one or more travelers;
determining, via the at least one processor, in real time and prior to a redemption event, whether the at least one traveler is authorized to use the bundled benefit based at least on traveler identification data, corporate eligibility rules, and supplier usage restrictions;
sending, via the at least one processor using an application programming interface (API) module, the bundled benefit to a merchandising system of the at least one travel supplier to present the bundled benefit to the at least one traveler, upon determining the at least one traveler is authorized to use the bundled benefit;
determining, via the at least one processor, whether the bundled benefit presented to the at least one traveler is redeemed by the at least one traveler; and
updating, via the at least one processor, the centralized ledger in real time upon determining the bundled benefit is redeemed by the at least one traveler, to synchronize the benefit status across the at least one travel supplier, the travel manager, and the at least one traveler.

12. The method of claim 11 further comprising preventing, via the at least one processor, an unauthorized use of the bundled benefit by the at least one traveler by enforcing one or more security mechanisms, upon determining the at least one traveler is not authorized to use the bundled benefit.

13. The method of claim 12, wherein the one or more security mechanisms comprises at least one of encrypted traveler identification mapping, single-account locking, and real-time benefit status validation.

14. The method of claim 11, wherein the traveler identification data comprises at least one of a traveler's name, an email address, an employee identification number, a department code, a corporate policy tier, and a loyalty account number.

15. The method of claim 11 further comprising storing and tracking, via the at least one processor using the centralized ledger, a usage history of each of the one or more travelers, including at least one of redeemed benefits, redemption dates, redemption channels, and remaining benefit entitlements.

16. The method of claim 11, wherein the benefit status of the one or more travel benefits comprises at least one of granted benefits, assigned benefits, redeemed benefits, or expired benefits for each traveler associated with the one or more enterprises.

17. The method of claim 11, wherein the predefined allocation rules comprises at least one of first-come-first-served distribution, traveler seniority-based distribution, travel frequency-based distribution, or route-specific allocation.

18. The method of claim 11, wherein the predefined allocation rules are stored in the memory communicatively coupled to the at least one processor, and dynamically applied by the administration module to assign the one or more travel benefits.

19. The method of claim 11 further comprising authenticating, via the at least one processor, the one or more travelers using a single sign-on mechanism during the redemption event, wherein the single sign-on mechanism is configured to perform multi-factor authentication comprising cryptographic token validation and dynamic session allocation for secure access to the at least one travel supplier's booking platform.

20. The method of claim 11, wherein the one or more travel benefits comprise at least one of lounge access passes, in-flight Wi-Fi vouchers, seat upgrades, priority boarding privileges, or loyalty points.
